(19) United States
(12) Patent Application Publication
(10) Pub. No.: US 2026/0369214 A1
(43) Pub. Date: Nov. 19, 2026

(54) SYSTEMS AND METHODS FOR MINIMIZING REFRESH RATES IN DISPLAY SYSTEMS

(71) Applicants: ADVANCED MICRO DEVICES, INC., SANTA CLARA, CA (US); ATI TECHNOLOGIES ULC, MARKHAM (CA)

(72) Inventors: Po-Ting Chen, Taipei (TW); Anthony WL Koo, Markham (CA)

(21) Appl. No.: 19/212,357

(22) Filed: May 19, 2025

(51) Int. Cl. G09G 3/20; G06F 3/147; G09G 3/36

(52) U.S. Cl. CPC G09G 3/2096; G06F 3/147; G09G 3/3611; G09G 2310/08; G09G 2320/0233; G09G 2320/0247; G09G 2320/0257; G09G 2330/023; G09G 2340/0435

(57) ABSTRACT

A graphics processor minimizes refresh rates in a display system that supports a range of refresh rates without introducing visual artifacts by providing first timing information indicating a first refresh rate to an application and second timing information indicating a second refresh rate to the display system, where the first refresh rate is higher than the second refresh rate. The graphics processor selects the second refresh rate by selecting a lowest refresh rate from a supported range of refresh rates of the display system that is a factor of the highest supported refresh rate or other primary refresh rate. After providing the second timing information to the display system, the graphics processor receives a frame for display from the application and subsequently provides the frame to the display system for display.

### BACKGROUND

A display system includes a screen that displays video rendered by a processor such as a graphics processing unit (GPU), which provides the rendered video to the display system in a stream of frames. A conventional GPU provides information representative of pixels in a frame during a vertical active region of the frame. In addition to the vertical active region, the frame includes a vertical blanking region. The GPU does not transmit active video information during the vertical blanking region of the frame, although metadata such as that used to define pixel formats can be transmitted during the vertical blanking region. For example, a high-definition frame can represent an image using 1080 active lines that include values of the pixels and 45 vertical blanking lines. The display system stores the pixels in a buffer prior to (or concurrently with) reading out the pixel values to present an image on a screen. The GPU provides the frames at a refresh rate that is determined by the GPU timing and the timing of the display system is synchronized to the GPU timing. For example, the GPU can provide frames at 60 Hz and the display system can read/display the frames at 60 Hz at times that are synchronized to the GPU.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system for minimizing refresh rates in display systems according to some implementations.

FIG. 2 is a timing diagram illustrating communications between an application, a GPU, and a display system according to some implementations.

FIG. 3 is a block diagram illustrating a temporal sequence of frames prior to and after receiving a frame for display on displays having different supported refresh rates according to some implementations.

FIG. 4 is a flow diagram of a method of minimizing refresh rates in display systems according to some implementations.

### DETAILED DESCRIPTION

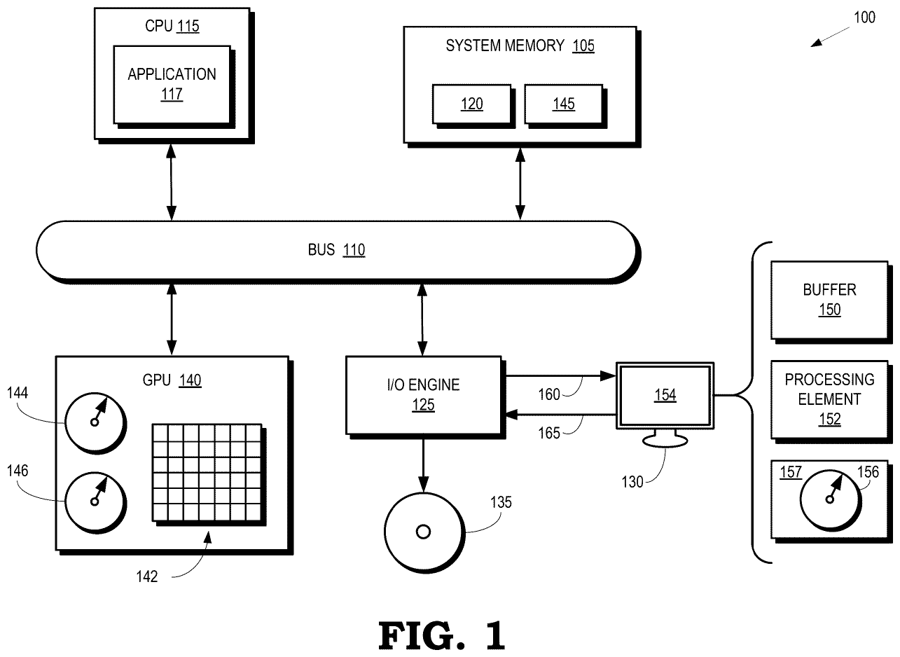

FIGS. 1-4 illustrate various techniques for saving power by minimizing refresh rates in display systems that support a range of refresh rates without introducing unwanted visual artifacts. Aspects of the present disclosure are directed to decoupling a constant virtual or emulated refresh rate reported to an application that may request or require the use of a constant refresh rate from an actual, variable refresh rate of a display system. By selecting the actual display refresh rate to be a lowest refresh rate from a supported range of refresh rates of the display system that is a factor of the highest supported refresh rate, a graphics processor can save power at the display while also ensuring that new frames received from the application will be able to be displayed at the application's expected time (e.g., at a next time slot or window for frame display defined by the virtual refresh rate reported to the application).

Selecting the actual display refresh rate in this way guarantees that new frames received from the application will be able to be displayed at the application's expected time, because the number of time slots for frame display in the actual refresh rate (e.g., 20 or 30 per second in the case of a 20 or 30 Hz actual refresh rate) will be a factor of the number of time slots in the virtual refresh rate reported to the application (e.g., 60 per second in the case of a 60 Hz virtual refresh rate). In other words, the duration of the time slots for frame display in the actual refresh rate (e.g., 1/20 of a second or 1/30 of a second in the case of a 20 or 30 Hz actual refresh rate) will be evenly divisible by the duration of the time slots for frame display in the virtual refresh rate reported to the application (e.g., 1/60 of a second in the case of a 60 Hz virtual refresh rate). Thus, the time slots of the virtual and actual refresh rates will remain synchronized without offset from one another, and the actual refresh rate can be modified to be equal to the virtual refresh rate such that the new frames received from the application will be able to be displayed at the application's expected time (e.g., the next 60 Hz time slot). As described further herein, this actual refresh rate selection ensures that whenever the graphics processor receives a new frame for display, it will be able to be displayed at the next time slot for frame display defined by the virtual refresh rate reported to the application regardless of the actual refresh rate selected for the display.

FIG. 1 is a block diagram of a processing system 100 for minimizing refresh rates in display systems according to some implementations. The processing system 100 includes or has access to a system memory 105 or other storage component that is implemented using a non-transitory computer readable medium such as a dynamic random-access memory (DRAM). However, some implementations of the memory 105 are implemented using other types of memory including static RAM (SRAM), nonvolatile RAM, and the like. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The processing system 100 includes a central processing unit (CPU) 115. Some implementations of the CPU 115 include multiple processing elements (not shown in FIG. 1 in the interest of clarity) that execute instructions concurrently or in parallel. The processing elements include processor cores, accelerators, and/or compute units. The CPU 115 is connected to the bus 110 and communicates with the memory 105 via the bus 110. The CPU 115 executes instructions such as program code 120 stored in the memory 105 in order to instantiate one or more applications, such as the application 117, and the CPU 115 stores information in the memory 105 such as the results of the executed instructions. The CPU 115 is also able to initiate graphics processing by issuing draw calls.

An input/output (I/O) engine 125 handles input or output operations associated with a display system 130, as well as other elements of the processing system 100 such as keyboards, mice, printers, external disks, and the like. The display system 130 supports a variable refresh rate (VRR) so that the display system 130 can present frames at refresh rates within a range up to a maximum refresh rate. The VRR typically corresponds to a variable vertical blanking region, which is within a range beginning at a minimum vertical blanking region that corresponds to the maximum refresh rate of the display system 130. The I/O engine 125 is coupled to the bus 110 so that the I/O engine 125 communicates with the memory 105, the CPU 115, or other entities that are connected to the bus 110. In the illustrated implementation, the I/O engine 125 reads information stored on an external storage component 135, which is implemented using a non-transitory computer readable medium such as a compact disc (CD), a digital video disc (DVD), and the like. The I/O engine 125 also writes information to the external storage component 135, such as the results of processing by the CPU 115.

The processing system 100 includes a graphics processing unit (GPU) 140 that renders images for presentation on the display system 130. For example, the GPU 140 renders objects to produce values of pixels that are provided to the display system 130, which uses the pixel values to display an image that represents the rendered objects. The GPU 140 includes one or more processing elements such as an array 142 of cores, accelerators, and/or compute units that execute instructions concurrently or in parallel. Some implementations of the GPU 140 are used for general purpose computing. In the illustrated implementation, the GPU 140 communicates with the memory 105 (and other entities that are connected to the bus 110) over the bus 110. However, some implementations of the GPU 140 communicate with the memory 105 over a direct connection or via other buses, bridges, switches, routers, and the like. In some implementations, the GPU 140 executes instructions stored in the memory 105 and the GPU 140 stores information in the memory 105 such as the results of the executed instructions. For example, the memory 105 stores a copy 145 of instructions that represent a program code that is to be executed by the GPU 140. The GPU 140 also includes one or more timing references, such as a first timing GPU reference 144 and a second GPU timing reference 146. In some implementations, the GPU 140 is an accelerator or subcomponent of the CPU 115, while in other implementations, the CPU 115 is an accelerator or subcomponent of the GPU 140. Furthermore, in some implementations, one or more of the CPU 115 and GPU 140 are incorporated into the display system 130. Accordingly, the architecture and arrangement of the processing system 100 need not correspond to the specific processing system 100 of FIG. 1 as long as similar functionality is provided, i.e., a processor configured to execute an application, such as the application 117, a processor (which in some implementations is the same processor that executes the application) configured to render a frame for display, and a display system, such as the display system 130, to display the frame.

The GPU 140 renders a stream of frames that is provided to the display system 130. In some implementations, the GPU 140 presents frames having a nominal vertical blanking region that corresponds to a nominal frame length rendered by the GPU 140. Some implementations of the display system 130 include a buffer 150 that stores the frames in the stream received from the GPU 140. In some implementations, the display system 130 also includes a processing element 152 that reads out the pixel values in the frames from the buffer 150 and uses the values to present an image on (or provide an image to) a screen 154, such as a liquid crystal display. The display system 130 also includes a display timing reference 156, which, in some implementations, is synchronized with one or more of the GPU timing references 144, 146 and, in some implementations, is used to display copies of captured frames in a panel self-refresh (PSR) mode. For example, the GPU 140 can provide frames at 60 Hz and the display system can read/display the frames on the screen 154 at 60 Hz at times that are synchronized to one or more of the GPU timing references 144, 146. In some implementations, the display timing reference 156 is implemented in a timing controller (TCON) chip 157, e.g., as an application-specific integrated circuit (ASIC) or other circuit, which also performs timing and synchronization operations for the display system 130. In some implementations, each frame in a video stream includes information representative of pixels in lines of the frame during a vertical active region of the frame. In addition to the vertical active region, each frame in the stream includes a vertical blanking region during which the GPU 140 does not transmit active video information. The GPU 140 provides the frames at a refresh rate that is determined by one of the GPU timing references 144, 146.

In some implementations, the display system 130 implements a PSR mode using a captured, or cached, frame that is stored in the buffer 150. The frame is captured prior to the GPU 140 and the display system 130 entering the PSR mode. During the PSR mode, the GPU 140 pauses providing frames to the display system 130 and enters a low power state. During the PSR mode, the display system 130 refreshes the screen 154 using the captured frame at periodic intervals determined by the display timing reference 156. For example, the processing element 152 reads the captured frame from the buffer 150 at periodic intervals and renders the captured frame to the screen 154 for display by the display system 130. The GPU 140 and the display system 130 exit the PSR mode in response to a screen update or activities such as a user providing input via a touch screen on the display system 130, a keyboard, a mouse, and the like.

In some implementations, the GPU 140 and the display system 130 exchange timing information to align timing in the GPU 140 and the display system 130 while also minimizing the refresh rate of the display system 130. In some implementations, the timing information 160 indicates a refresh rate that is to be used by the display system 130 when refreshing the screen 154. For example, the GPU 140 can determine the refresh rate, which is then used to determine a total duration of a frame presented by the GPU 140 (including a vertical active region and a vertical blanking region) and a duration of the vertical blanking region of the frame presented by the GPU 140. The timing information 160 is provided to the display system 130, which, in some implementations, modifies its refresh rate based on the received timing information by increasing the duration of the vertical blanking region of the frames retrieved from the buffer 150 and displayed in PSR mode. In some implementations, the display system 130 communicates supported refresh rate information 165 indicating a supported range of refresh rates.

In some implementations, in order to minimize power usage, it is desirable to minimize the refresh rate of the display system 130 to reduce the number of times a frame has to be refreshed or redrawn per second, minimizing power consumption by the display system 130, and, in some implementations, to reduce the number of frames the GPU 140 has to transmit to the display system 130, minimizing power consumption by, e.g., the GPU 140, bus 110, and I/O engine 125. However, in many situations, an application 117 requires a constant refresh rate, e.g., in order to limit visual artifacts that might result from using VRRs. For example, when an application expects the display system 130 to use a constant refresh rate but the display system 130 uses a VRR, the application 117 could provide frames under the assumption that the frames will be displayed at a certain time (e.g., at a next 60 Hz time slot for frame display) while the display system 130 actually displays those frames earlier or later than expected, which can result in visual artifacts such as: tearing, where parts of multiple frames appear on the screen simultaneously, causing a disjointed image; stutter, which causes noticeable pauses or frame drops in motion, often due to performance issues or inconsistent frame delivery; and/or judder, where uneven or jerky motion is caused by frame rate mismatch.

In some implementations, in order to comply with an application's expectation of a constant refresh rate while also minimizing a refresh rate of the display system 130 and avoiding visual artifacts, the GPU 140 maintains one or more timing references 144, 146. In some implementations, the GPU 140 only maintains one timing reference, e.g., the first timing reference 144, and derives a second timing reference, e.g., the second timing reference 146, from the first timing reference 144. In order to ensure compliance with an expected refresh rate defined or requested by the application 117, the GPU maintains the first timing reference 144 at the expected refresh rate. For example, in some implementations, if the application 117 requests a refresh rate of 60 Hz, the GPU 140 maintains the first timing reference 144 at 60 Hz and provides timing information to the application 117, such as a V-Sync signal, at 60 Hz.

In some implementations, the GPU 140 receives information indicating a supported range of refresh rates from the display system 130 and selects the second refresh rate based on a highest supported refresh rate of the display system 130. For example, in some implementations, to minimize the refresh rate of the display system 130 without introducing visual artifacts, the GPU 140 selects the second timing reference 146 to be a lowest refresh rate from the supported range of refresh rates of the display system 130 that is a factor of the highest supported refresh rate. In this way, time slots or windows for frame display expected by the application 117 (e.g., 1/60 second slots for 60 Hz) are able to be matched at the display system 130 without introducing any visual artifacts or unexpected delays. For example, rather than 60 Hz, the GPU 140 can select the second timing reference 146 to be 30 Hz ( 1/30 second slots), 20 Hz ( 1/20 second slots), 15 Hz ( 1/15 second slots), or 10 Hz ( 1/10 second slots), as the 1/60 second slots at 60 Hz are guaranteed to fit evenly into any of these ranges. For example, one 1/30 second slot at 30 Hz is equal to two 1/60 second slots at 60 Hz; one 1/20 second slot at 20 Hz is equal to three 1/60 second slots at 60 Hz; one 1/15 second slot at 15 Hz is equal to four 1/60 second slots at 60 Hz; and one 1/10 second slot at 10 Hz is equal to six 1/60 second slots at 60 Hz.

By selecting a lowest refresh rate from the supported range of refresh rates of the display system 130 that is a factor of the highest supported refresh rate for the second timing reference 146, the GPU 140 guarantees that when the application 117 sends a new frame for display, the display system 130 will be able to display that frame at the next 60 Hz slot even when the display system 130 is actually using a lower refresh rate based on the second timing reference 146. Notably, substantially the same advantage is achievable by selecting an intermediate refresh rate that is lower than the highest supported refresh rate but still within the supported range of refresh rates of the display system 130 as the primary refresh rate and selecting a lower refresh rate that is a factor of the intermediate refresh rate for the second timing reference 146. For example, in some implementations, an application may request that the GPU 140 use or otherwise select a primary refresh rate that is lower than the highest supported refresh rate, e.g., when the application intends to use a different refresh rate from the highest supported refresh rate as its maximum refresh rate. However, if the GPU 140 instead selected a refresh rate that is not a factor of the highest supported refresh rate (or an intermediate primary refresh rate) of the display system 130 for the second timing reference 146, such as 25 Hz in the case where the highest supported refresh rate is 60 Hz, the application 117 could send a new frame for display that may not be able to be displayed at the next 60 Hz slot due to the 25 Hz slots not perfectly aligning with the 60 Hz slots, which could introduce undesirable visual artifacts. Although the GPU 140 can instruct the display system 130 to change refresh rates at any time, the display system 130 is typically only able to display a new frame at a next time slot based on its maximum refresh rate. Thus, if a frame is provided to the display system 130 less than 1/60 seconds from the start of a 60 Hz slot (e.g., based on the first timing reference 144), the display system will not be able to display the frame exactly at the start of the 60 Hz slot.

Accordingly, in order to minimize the refresh rate of the display system 130 to save power without introducing undesirable visual artifacts in the displayed images, a processor, such as the GPU 140, includes circuitry configured to provide first timing information based on the first timing reference 144, indicating a first refresh rate, to the application 117 while providing second timing information based on the second timing reference 146, indicating a second refresh rate, to a display system that supports a range of refresh rates, where the first refresh rate is higher than the second refresh rate. Then, when the GPU 140 receives a frame for display from the application 117 after providing the second timing information to the display system 130, the GPU 140 can provide the frame to the display system 130 at a next time slot expected by the application 117 (e.g., a next 60 Hz slot) without any delay or image tearing.

Notably, in some implementations, rather than directly providing the refresh rate to the display system 130, the GPU 140 provides timing information in the form of a factor or multiple of the highest or intermediate refresh rate to the GPU 140 as a frame skip value. For example, in some implementations, if the highest or intermediate selected primary refresh rate is 120 Hz, the GPU 140 provides timing information comprising an indication of the factor value “3” to the display system 130 to indicate that the display should refresh once every three periods or time slots, resulting in an effective refresh rate of 40 Hz, instead of providing a direct indication of a 40 Hz refresh rate. In some implementations, the display system includes a counter, in hardware or software, to identify how many lines or how much time has passed before doing a screen refresh. Accordingly, in some implementations, the display system 130 uses the factor value as a multiplier for the counter. For example, in some implementations, the display system 130 determines a timing for a next display refresh based on a multiplier derived from a factor value and/or one or more line number, frame number, or time counters.

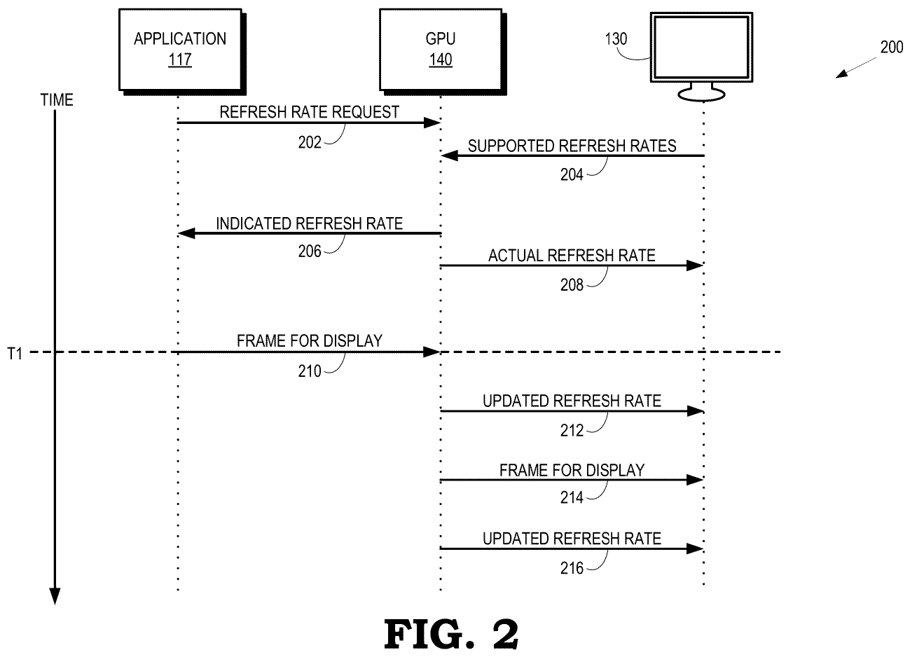

FIG. 2 is a timing diagram 200 illustrating communications between an application, such as the application 117, a GPU, such as the GPU 140, and a display system, such as the display system 130, according to some implementations. As shown in FIG. 2, in some implementations, the GPU 140 receives a refresh rate request 202 from the application 117 to provide frames to a display system (e.g., display system 130) that supports a range of refresh rates at a first refresh rate (e.g., 60 Hz, 120 Hz, etc., corresponding to the first timing GPU reference 144). Prior to, at the same time as, or subsequent to the refresh rate request 202 (as shown in FIG. 2 for clarity), the GPU 140 receives an indication of a range of supported refresh rates 204 from the display system 130. Although not shown in FIG. 2, in some implementations, the GPU 140 sends a request for the range of supported refresh rates 204 to the display system 130 that triggers the display system 130 to transmit the indication 204.

After receiving the refresh rate request 202 and indication of a range of supported refresh rates 204, the GPU 140 provides an indicated, constant refresh rate 206 to the application 117 (e.g., equal to or less than the refresh rate in the refresh rate request 202 and sets the first timing GPU reference 144 accordingly) and selects a second refresh rate (e.g., corresponding to the second timing GPU reference 146) by selecting a lowest refresh rate from the supported range of refresh rates that is a factor of a highest supported refresh rate of the display system 130. For example, in some implementations, if the display system 130 supports 25-120 Hz, the GPU 140 selects 30 Hz, as 30 Hz is the lowest refresh rate from the supported range of refresh rates that is a factor of 120 Hz. The GPU 140 then provides timing information indicating the second, lower, refresh rate to the display system as the actual refresh rate 208 for the display system 130.

As shown in FIG. 2, at time T1, the application 117 provides a frame for display 210. In some implementations, the GPU 140 then provides timing information indicating an updated refresh rate 212 to the display system 130 based on a timing of the frame and the first refresh rate. For example, if the display system 130 is operating at a reduced refresh rate (e.g., 15 Hz) compared to the indicated refresh rate 206 (e.g., 60 Hz) and the next 60 Hz time slot is not aligned with the next 15 Hz time slot, the GPU 140 provides timing information indicating an updated refresh rate 212 (e.g., 60 Hz) to the display system 130. However, if the next 60 Hz time slot is aligned with the next 15 Hz time slot, the GPU 140 does not need to send the indication of an updated refresh rate 212. After ensuring that the frame for display 210 will be displayed at the next timeslot expected by the application 117 (e.g., the next 60 Hz time slot) by, if necessary, providing timing information indicating an updated refresh rate 212 to the display system 130, the GPU 140 provides the frame for display 214 to the display system. After providing the frame for display 214, the GPU 140 provides timing information indicating a further updated refresh rate 216 to the display system 130, e.g., again reducing the actual refresh rate of the display system 130 to the lowest refresh rate from the supported range of refresh rates that is a factor of the highest supported refresh rate of the display system 130. In some implementations, instead of immediately reducing the refresh rate of the display system 130, the GPU 140 delays the reduction for a threshold duration and/or staggers the reduction over time such that the display system 130 ramps down from a maximum refresh rate (e.g., 60 Hz) to lower refresh rates over a period of time (e.g., 30 Hz, then 20 Hz, then 10 Hz) as long as the application 117 does not provide any updated frames over that period.

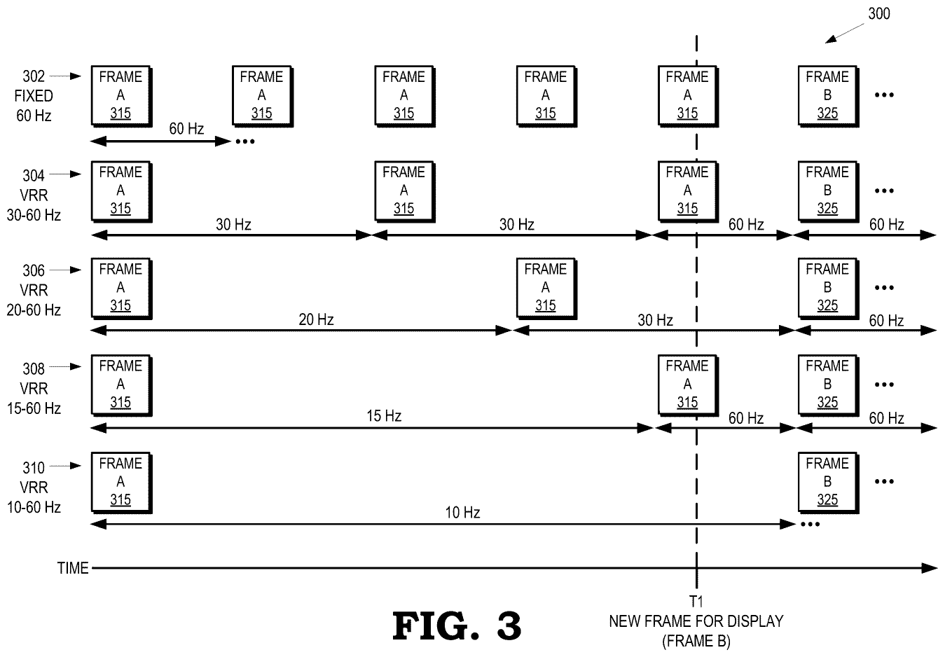

FIG. 3 is a block diagram 300 illustrating a temporal sequence of frames prior to and after receiving a frame for display on displays having different supported refresh rates according to some implementations. For example, as shown in row 302, which represents a display operating at a fixed refresh rate of 60 Hz, the display has to refresh the screen every 1/60 seconds, i.e., at each 60 Hz time slot even if the same frame, frame A 315, is displayed in every slot without being updated. Although repeated frame transmissions by a GPU can be avoided by using PSR mode, which saves some power as discussed above, the display system still has to self-refresh the screen at each 60 Hz slot, which requires a nontrivial amount of power that adds up over time. However, when an application, such as the application 117 of FIGS. 1 and 2, sends a new frame for display at time T1, such as frame B 325, the display system can guarantee that the new frame will be able to be displayed at the next 60 Hz time slot, as shown in FIG. 3.

In order to save power when a display system has VRR capabilities without introducing undesirable visual artifacts, as discussed above, the GPU 140 selects a lowest refresh rate from the supported range of refresh rates of the display system 130 that is a factor of the highest supported refresh rate for the second timing reference 146, e.g., the actual refresh rate 208 of FIG. 2. For example, in some implementations, as shown in row 304 of FIG. 3, which represents a display capable of a range of refresh rates from 30-60 Hz, the GPU 140 sets the second timing reference 146 to 30 Hz. As shown in row 306, which represents a display capable of a range of refresh rates from 20-60 Hz, the GPU 140 sets the second timing reference 146 to 20 Hz. As shown in row 308, which represents a display capable of a range of refresh rates from 15-60 Hz, the GPU 140 sets the second timing reference 146 to 15 Hz. As shown in row 310, which represents a display capable of a range of refresh rates from 10-60 Hz, the GPU 140 sets the second timing reference 146 to 10 Hz.

In each instance represented by rows 304, 306, 308, and 310, when the GPU 140 receives a new frame (i.e., frame B 325) for display at time T1, the GPU 140 can guarantee that the new frame will be able to be displayed at the next 60 Hz time slot, just as it would be if the display system were operating at a fixed 60 Hz refresh rate, like in row 302. When the GPU 140 receives the new frame, as shown in rows 304, 306, and 308, the GPU 140 immediately sends an updated refresh rate (e.g., 60 Hz) to the display system 130 such that the new frame will be displayed at the next 60 Hz time slot. However, as shown in row 310, as the next time slot at 10 Hz aligns with the next 60 Hz time slot, the GPU 140 does not necessarily have to send an updated refresh rate to the display system 130. Although, in some implementations, the GPU 140 will still send an updated refresh rate to the display system 130 in anticipation of having to display further updated frames (e.g., based on historical data or heuristics), in some implementations, the GPU 140 does not update the refresh rate of the display system 130 and instead lets the display system 130 maintain the lower refresh rate 10 Hz, particularly when the GPU 140 can predict (e.g., based on historical data or heuristics) that it is unlikely to receive another new frame in the near future.

Notably, although the display of rows 304 and 308 effectively changes to 60 Hz and the display of row 306 effectively changes to 30 Hz prior to the GPU 140 receiving the new frame for display at time T1, this is not necessarily due to the GPU 140 instructing the display system 130 to change the refresh rate prior to time T1. Instead, in some implementations, these effective refresh rate changes are a result of the GPU 140 instructing the display system to display the new frame B 325 at the next 60 Hz time slot, which effectively truncates the larger time slot corresponding to 30, 20, or 15 Hz into an effective time slot of 60, 30, or 60 Hz, respectively, as shown in FIG. 3.

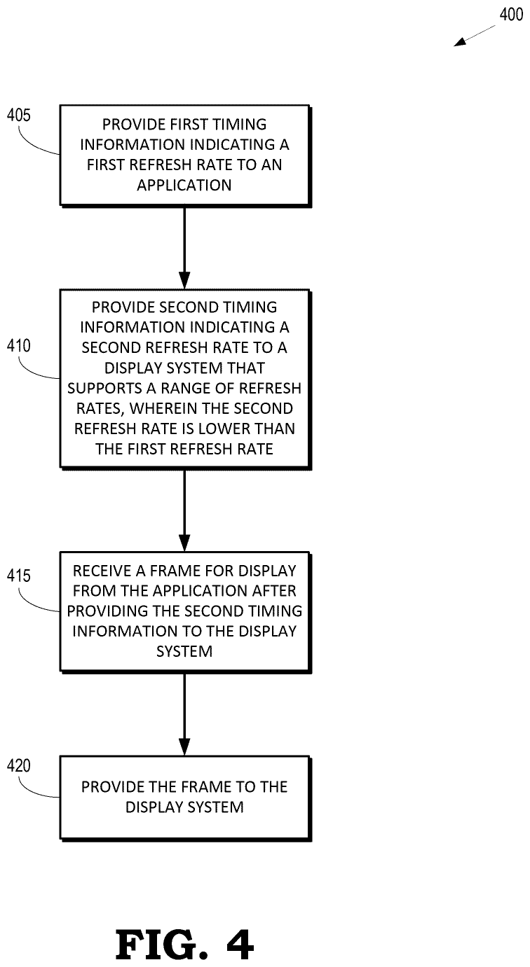

FIG. 4 is a flow diagram of a method 400 of minimizing refresh rates in display systems according to some implementations. The method 400 is implemented in a processing system such as the processing system 100 using the GPU 140 and the display system 130 of FIG. 1. At block 405, the GPU 140 provides first timing information (such as the indicated refresh rate 206, which corresponds to the first timing GPU reference 144) indicating a first refresh rate to an application 117. At block 410, the GPU 140 provides second timing information (such as the actual refresh rate 208, which corresponds to the second timing GPU reference 146) indicating a second refresh rate to a display system that supports a range of refresh rates, such as the display system 130, where the second refresh rate is lower than the first refresh rate. At block 415, the GPU 140 receives a frame for display from the application 117 after providing the second timing information to the display system, and, at block 420, the GPU 140 provides the frame to the display system.

In some implementations, as discussed above, the method 400 further includes receiving information indicating the supported range of refresh rates from the display system and selecting the second refresh rate based on a highest supported refresh rate of the display system. For example, as described above, in some implementations, the method 400 includes selecting the second refresh rate by selecting a lowest refresh rate from the supported range of refresh rates that is a factor of the highest supported refresh rate. In some implementations, as described above, the method 400 further includes, prior to providing the frame to the display system, providing third timing information indicating a third refresh rate to the display system based on a timing of the frame and the first refresh rate. In some implementations, as described above, the method 400 further includes providing fourth timing information indicating a fourth refresh rate to the display system after providing the frame to the display system. In some implementations, the fourth refresh rate is lower than the third refresh rate. In some implementations, the first timing information comprises a vertical synchronization (V-Sync) signal.

In some implementations, the apparatus and techniques described above are implemented in a system including one or more integrated circuit (IC) devices (also referred to as integrated circuit packages or microchips), such as the processing system 100 and method 400 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., CD, digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation—[entity] configured to [perform one or more tasks]—is used herein to refer to physical structure e.g., electronic circuitry. More specifically, this formulation is used to indicate that this physical structure is arranged to perform the one or more tasks during operation. Such physical structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

1. A method comprising:
providing first timing information indicating a first refresh rate to an application;
providing second timing information indicating a second refresh rate to a display system that supports a range of refresh rates, wherein the second refresh rate is lower than the first refresh rate;
receiving a frame for display from the application after providing the second timing information to the display system; and
providing the frame to the display system based on the second refresh rate.

2. The method of claim 1, further comprising:
receiving information indicating the supported range of refresh rates from the display system; and
selecting the second refresh rate based on a primary refresh rate, wherein the primary refresh rate is the lower of a highest supported refresh rate of the display system and a highest refresh rate indicated by the application.

3. The method of claim 2, further comprising selecting the second refresh rate by selecting a lowest refresh rate from the supported range of refresh rates that is a factor of the primary refresh rate.

4. The method of claim 1, further comprising, prior to providing the frame to the display system, providing third timing information indicating a third refresh rate to the display system based on a timing of the frame and the first refresh rate, wherein the third refresh rate is higher than the second refresh rate.

5. The method of claim 4, further comprising staggering a reduction in refresh rate by providing fourth timing information indicating a fourth refresh rate to the display system after providing the frame to the display system, wherein the fourth refresh rate is lower than the third refresh rate and higher than the second refresh rate.

6. The method of claim 5 further comprising delaying the reduction in refresh rate based on a threshold duration of time.

7. The method of claim 1, wherein the first timing information comprises a vertical synchronization (V-Sync) signal.

8. A method comprising:
receiving a request from an application to provide frames at a first refresh rate to a display system that supports a range of refresh rates;
receiving information indicating a supported range of refresh rates from the display system;
selecting a second refresh rate by selecting a lowest refresh rate from the supported range of refresh rates that is a factor of a primary refresh rate, wherein the primary refresh rate is the lower of a highest supported refresh rate of the display system and a highest refresh rate indicated by the application;
providing first timing information indicating the second refresh rate to the display system;
receiving a frame for display from the application after providing the first timing information to the display system; and
providing the frame to the display system based on the second refresh rate.

9. The method of claim 8, further comprising providing second timing information indicating the first refresh rate to the application, wherein the second refresh rate is lower than the first refresh rate.

10. The method of claim 8, further comprising, prior to providing the frame to the display system, providing second timing information indicating a third refresh rate to the display system based on a timing of the frame and the first refresh rate, wherein the third refresh rate is higher than the second refresh rate.

11. The method of claim 10, further comprising staggering a reduction in refresh rate by providing fourth timing information indicating a fourth refresh rate to the display system after providing the frame to the display system, wherein the fourth refresh rate is lower than the third refresh rate and higher than the second refresh rate.

12. The method of claim 11, further comprising delaying the reduction in refresh rate based on a threshold duration of time.

13. The method of claim 8, wherein the first timing information comprises a vertical synchronization (V-Sync) signal.

14. A processor, comprising circuitry configured to:
provide first timing information indicating a first refresh rate to an application;
provide second timing information indicating a second refresh rate to a display system that supports a range of refresh rates, wherein the first refresh rate is higher than the second refresh rate;
receive a frame for display from the application after providing the second timing information to the display system; and
provide the frame to the display system based on the second refresh rate.

15. The processor of claim 14, wherein the circuitry is further configured to:
receive information indicating the supported range of refresh rates from the display system; and
select the second refresh rate based on a primary refresh rate, wherein the primary refresh rate is the lower of a highest supported refresh rate of the display system and a highest refresh rate indicated by the application.

16. The processor of claim 15, wherein the circuitry is further configured to select the second refresh rate by selecting a lowest refresh rate from the supported range of refresh rates that is a factor of the primary refresh rate.

17. The processor of claim 14, wherein the circuitry is further configured to, prior to providing the frame to the display system, provide third timing information indicating a third refresh rate to the display system based on a timing of the frame and the first refresh rate, wherein the third refresh rate is higher than the second refresh rate.

18. The processor of claim 17, wherein the circuitry is further configured to stagger a reduction in refresh rate by provide fourth timing information indicating a fourth refresh rate to the display system after providing the frame to the display system, wherein the fourth refresh rate is lower than the third refresh rate and higher than the second refresh rate.

19. The processor of claim 18, wherein the circuitry is further configured to delay the reduction in refresh rate based on a threshold duration of time.

20. The processor of claim 14, wherein the first timing information comprises a vertical synchronization (V-Sync) signal.
